(19) United States
(12) Patent Application Publication
(10) Pub. No.: US 2007/0212668 A1
(43) Pub. Date: Sep. 13, 2007

(54) USER INTERFACE DEVICE AND METHOD FOR THE VISUALLY IMPAIRED

(76) Inventors: Junichi TAKAMI, Yokohama (JP); Bin Lu, Tokyo (JP)

Correspondence Address: KNOBLE & YOSHIDA, LLC;Eight Penn Center, Suite 1350, 1628 John F. Kennedy Blvd., Philadelphia, PA, 19103, US

(21) Appl. No.: 11/746,942

(22) Filed: May 10, 2007

Related U.S. Application Data
(62) Division of application No. 10/226,926, filed on Aug. 23, 2002.

(30) Foreign Application Priority Data
Aug. 24, 2001 (JP) 2001-254779

(51) Int. Cl. G09B 21/00

(52) U.S. Cl. 434/113; 434/116

(57) ABSTRACT

The user interface is provided for the visually impaired to operate a multi-function devices. The user interface is based upon a combination of tactile sensation, tactile position, and sound. The tactile sensation includes the Braille expressions as well as any marker on a template. The tactile position includes the relative position of the user hand on a touch panel. In combination with the tactile sensation or tactile position, the sound interface offers additional information to help the operation of the multi-function machine.

### FIELD OF THE INVENTION

The current invention is generally related to user interface for operation of various devices such as an information input device, an automatic transaction device, a ticket vending machine and an image output device, and more particularly related to the user interface based upon tactile sensation for specifying operations.

### BACKGROUND OF THE INVENTION

Multi-function peripherals (MFP) perform a predetermined set of combined functions of a copier, a facsimile machine, a printer, a scanner and other office automation (OA) devices. In operating a sizable number of functions in a MFP, an input screen is widely used in addition to a keypad. The screen display shows an operational procedure in text and pictures and provides a designated touch screen area on the screen for inputting a user selection in response to the displayed operational procedure.

It is desired to improve an office environment for people with disability so that these people can equally contribute to the society as people without disability. In particular, the section 508 of the Rehabilitation Act has become effective on Jun. 21, 2001 in the United States, and the federal government is required by law to purchase information technology related devices that are usable by people with disability. State governments, related facilities and even private sectors appear to follow the same movement.

Despite the above described movement, the operation of the MFP is becoming more and more sophisticated. Without displaying instructions on a display screen or a touch panel, it has become difficult to correctly operate the MFP. Because of the displayed instructions, the operation of the MFP has become impractical for the visually impaired. For example, when a visually impaired person operates a MFP, since he or she cannot visually confirm a designated touch area on a screen, the operation is generally difficult. For this reason, the visually impaired must memorize a certain operational procedure as well as a touch input area on the screen. Unfortunately, even if the visually impaired person memorizes the procedure and the input area, when the operational procedure or the input area is later changed due to future updates or improvements, the current memorization becomes invalid.

One prior art improved the above described problem by providing audio information for the visual information when a MFP is notified of the use by a visually impaired person. The visually impaired person indicates to the MFP by inserting an ID card indicative of his or her visual disability or inserting an ear phone into the MFP. The audio information is provided by a voice generation device. Alternatively, tactile information is provided by a Braille output device.

An automatic teller machine (ATM) is also equipped with a device to recognize a visually impaired person when either a predetermined IC card or a certain ear phone is inserted in the ATM. In order to withdraw or deposit money into his or her own account, the instructions are provided in Braille or audio when the ATM recognizes that a visually impaired person is operating. An input is through a keyboard with Braille on its surface.

Unfortunately, based upon a ratio of the disabled population to the normal population, the extra costs associated with the above described additional features for the disabled are prohibitive to make every user machine equipped with the additional features. Furthermore, if a mixture of the ATMs exists with and without the handicapped features, the users probably will be confused.

Japanese Patent Publication Hei 11-110107 discloses an information input device that includes a transparent touch panel over a display screen of a display device. A part of the touch panel is devoted as a screen search start button to change the operation mode to a screen search mode. In the screen search mode, the user interface outputs through a speaker a corresponding voice message describing an operation button on the touch panel. The above voice user interface enables the visually impaired to operate the operational panel that is commonly used for the operators without any visual impairment. On the other hand, it is necessary for the visually impaired to switch to the screen search mode and to touch the entire touch panel by finger. Because of the above tactile operation, it takes additional handling.

For the above reasons, it remains desirable to provide an operational device with the visually impaired to specify various operations through a touch panel.

### SUMMARY OF THE INVENTION

In order to solve the above and other problems, according to a first aspect of the current invention, a method of user interfacing a visually impaired user with a multifunction device, including the steps of: assigning a predetermined function to a predetermined surface area of a touch panel; placing a template over the touch panel, a partial template area of the template corresponding to the predetermined surface area of the touch panel, the partial template area providing a non-visual cue for identification; inputting an inquiry about the partial template area based upon the non-visual cue; outputting a voice message about the partial template area in response to the inquiry; and selecting the predetermined function by making a contact ultimately with the predetermined surface area.

According to a second aspect of the current invention, a method of user interfacing a visually impaired user with a multifunction device, including the steps of: dividing a touch panel into predetermined surface areas that resemble a piano keyboard; assigning a predetermined function to each of the predetermined surface areas; touching one of the predetermined surface areas in a first predetermined manner indicative of an inquiry; outputting a sound output about the one of the surface areas in response to the inquiry; and touching one of the predetermined surface areas in a second predetermined manner to selecting the predetermined function.

According to a third aspect of the current invention, a user interface system for facilitating a visually impaired operator to use a multi-function device, including: a touch input unit for non-visually indicating predetermined functions and for receiving a tactile input; a control unit connected to the touch input unit for determining a control signal based upon the tactile input; and a sound generating unit connected to the control unit for outputting a sound in response to the control signal.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagram illustrating a first template of a first preferred embodiment according to the current invention.

FIG. 2 is a diagram illustrating a second template of the first preferred embodiment according to the current invention.

FIG. 3 is a diagram illustrating a third template of the first preferred embodiment according to the current invention.

FIG. 4 is a table illustrating an exemplary data structure to be used with the current invention.

FIG. 5 is a diagram illustrating the operation user interface device of the first preferred embodiment according to the current invention.

FIG. 6 is a flow chart illustrating steps involved in a preferred process of the user interface according to the current invention.

FIG. 7 is a diagram illustrating a fourth template of a second preferred embodiment according to the current invention.

FIG. 8 is a diagram illustrating a fifth template of a second preferred embodiment according to the current invention.

FIG. 9 is a diagram illustrating a sixth template of a second preferred embodiment according to the current invention.

FIG. 10 is a diagram illustrating a seventh template of a third preferred embodiment according to the current invention.

FIG. 11 is a diagram illustrating the operation user interface device of the third preferred embodiment according to the current invention.

### DETAILED DESCRIPTION OF THE PREFERRED EMBODIMENT(S)

Based upon incorporation by external reference, the current application incorporates all disclosures in the corresponding foreign priority document (JPAP2001-254779) from which the current application claims priority.

In general, a function area is provided on an operation panel to operate a device, and a particular function is selected by touching on the touch panel over the operational panel. In a first preferred embodiment, a template is placed above the operational panel to indicate a corresponding function of the touch panel so that the visually impaired can also identify a relevant function area. In the following, one of three templates is used to operate a device according to the current invention.

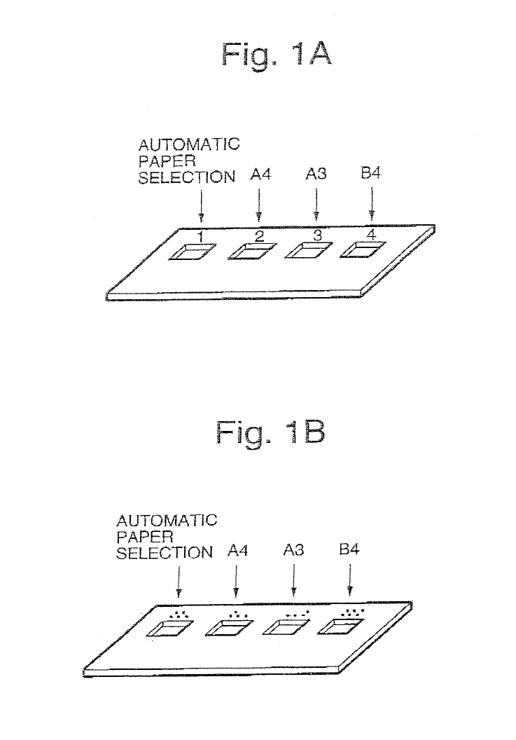

Referring now to the drawings, wherein like reference numerals designate corresponding structures throughout the views, and referring in particular to FIG. 1, a diagram illustrates a first template of a first preferred embodiment according to the current invention. The first template includes a plate, a predetermined number of holes and a corresponding tactile indicator near each of the holes. The first plate is placed over the touch panel so that the holes coincide over the function areas on the touch panel. In FIG. 1A, the tactile indicator is a series of numbers 1 through 4 while in FIG. 1B, the same numbers are indicated by Braille. When an operator uses the operation device or user interface with the above described template, the template is placed over the touch panel. The visually impaired user touches the numbers or read the Braille expressions of the numbers on the template. When a number is inputted via keypad, the voice message is outputted to provide the corresponding function area name and helpful description of the function represented by the touch panel area. Based upon the voice message, the user selects a desired function by touching the touch panel area surface through the corresponding hole on the template that indicates the number.

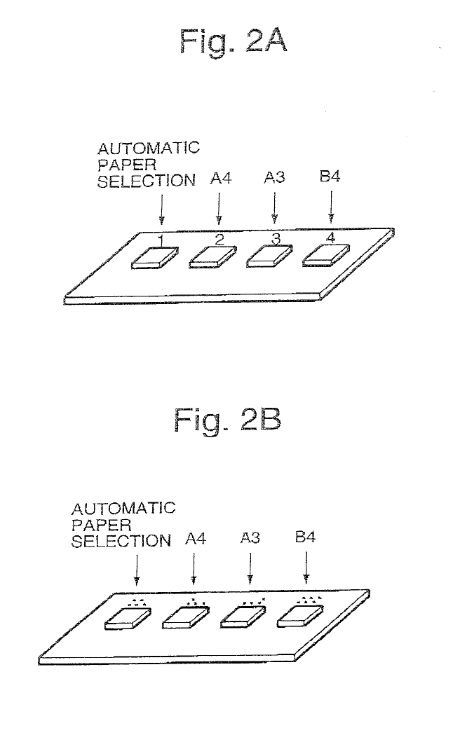

Now referring to FIG. 2, a diagram illustrates a second template of the first preferred embodiment according to the current invention. The second template includes a plate, a predetermined number of pliable buttons and a corresponding tactile indicator near each of the buttons. The second plate is placed over the touch panel so that the buttons coincide over the function areas on the touch panel. In FIG. 2A, the tactile indicator is a series of numbers 1 through 4 while in FIG. 2B, the same numbers are indicated by Braille. When an operator uses the operation device or user interface with the above described template, the template is placed over the touch panel. The visually impaired user touches the numbers or read the Braille expressions of the numbers on the template. When a number is inputted via keypad, the voice message is outputted to provide the corresponding function area name and helpful description of the function represented by the touch panel area. Based upon the voice message, the user selects a desired function by pressing the corresponding button on the template that indicates the number to touch the touch panel area surface.

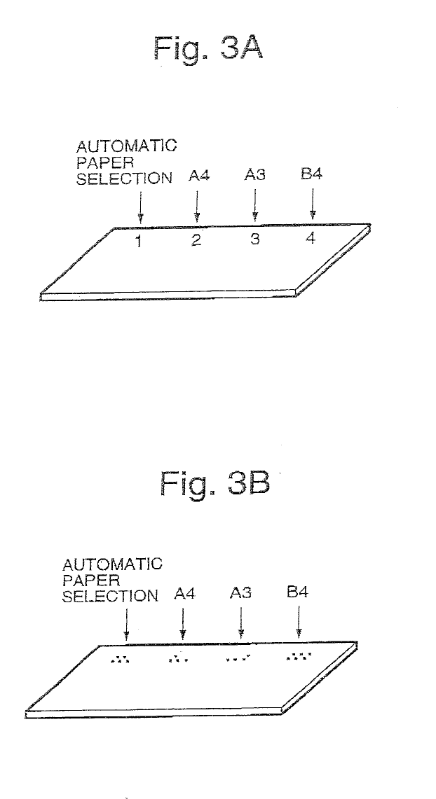

Now referring to FIG. 3, a diagram illustrates a third template of the first preferred embodiment according to the current invention. The third template includes a thin seal and a corresponding tactile indicator. The thin seal template is placed over the touch panel so that the tactile indicator is near each of touch panel areas on the touch panel. In FIG. 3A, the tactile indicator is a series of numbers 1 through 4 while in FIG. 3B, the same numbers are indicated by Braille. When an operator uses the operation device or user interface with the above described template, the template is placed over the touch panel. The visually impaired user touches the numbers or read the Braille expressions of the numbers on the template. When a number is inputted via keypad, the voice message is outputted to provide the corresponding function area name and helpful description of the function represented by the touch panel area. Based upon the voice message, the user selects a desired function by touching the touch panel area surface through the corresponding seal area on the third template that indicates the number.

The above described templates each have a unique template number for each operational display. Similarly, the operational displays each have a unique operation number that matches the unique template number. The uniquely identified templates are stored in a storage area that resembles like a juke box. In response to a selected unique number, if the selected template is not yet placed on the touch panel, the selected template is taken out from the juke box and placed over the touch panel of the operational unit. The visually impaired user touches the template to input a certain number via keypad for inquiry. In response, the voice message is outputted to provide the corresponding function area name and helpful description of the inputted number. Based upon the voice message, the user selects a desired function by touching the touch panel area surface through the corresponding seal area on the third template that indicates the number.

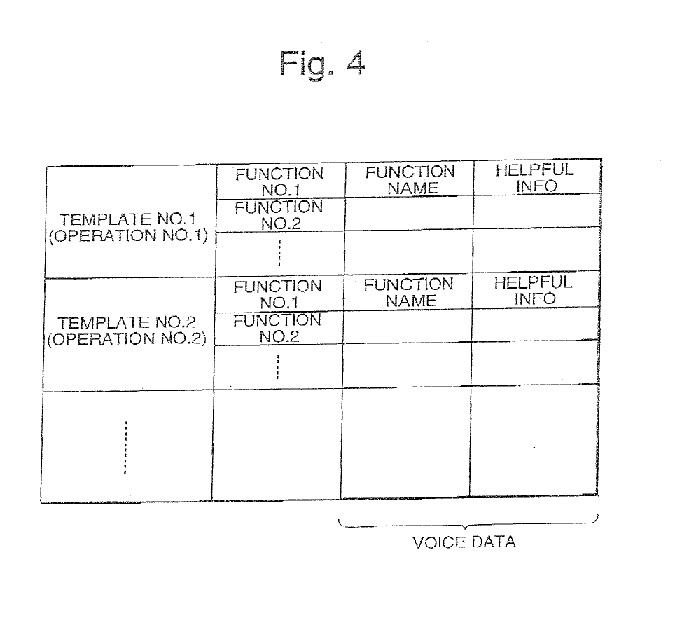

Now referring to FIG. 4, a table illustrates an exemplary data structure to be used with the current invention. An exemplary table includes data for data for the template numbers, function numbers, function names and helpful info. For each template, a function number corresponds to a predetermined function area and also specifies the corresponding function name and helpful information. A pair of the function name and helpful information is voice data or text data that is stored in a separate voice data file for a particular template. In other words, a number of voice data files corresponds to a number of functions in a particular template. If the above information is stored in the text data format, a voice synthesis process generates voice data for output.

In the following description, the term, user is interchangeably used with the visually impaired. Furthermore, the process mode for the visually normal users will be called the visual operation mode. On the other hand, the process mode for the visually impaired users will be called the non-visual operation mode.

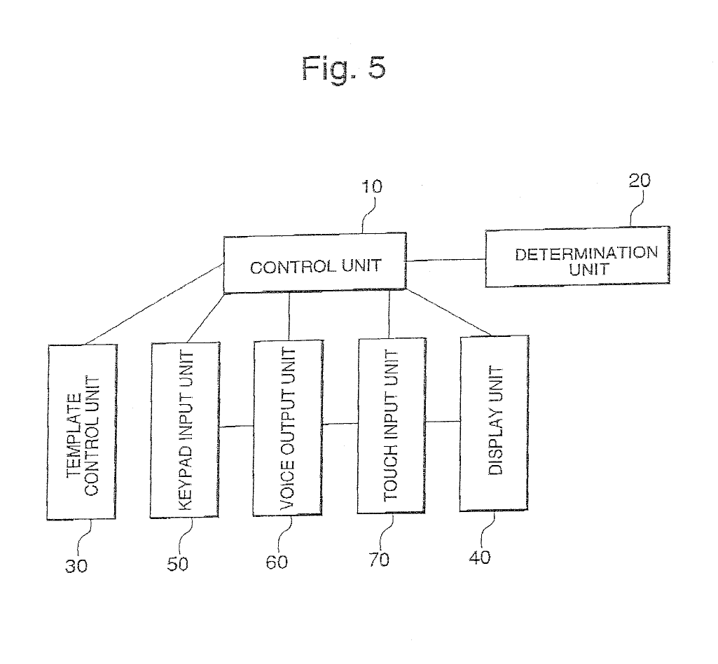

Now referring to FIG. 5, a diagram illustrates the operation user interface device of the first preferred embodiment according to the current invention. The preferred embodiment includes a control unit 10, a determination unit 20, a template control unit 30, a display unit 40, a keypad input unit 50, a voice output unit 60 and a touch input unit 70. The control unit 10 performs various initialization steps. The control unit 10 also controls the entire operation user device as well as the user specified information. During the initialization of the device, the operation panel screen displays an initial operation display, and the corresponding template is placed on the operation panel. The determination unit 20 determines whether or a current user is visually impaired in response to the control unit 10. The determination unit 20 determines the above inquiry based upon the information from the control unit 10. The above information is generated when a headset including a headphone and a microphone is inserted in the user interface device. The information is also generated in response to a certain predetermined key or a non-contact IC card. The non-contact IC card contains information on the visually impaired identification or the historical operational record of a particular individual. The template control unit 30 fetches a specified template from the juke box storage and places it on the operational panel in response to the control unit 10. On the operational panel screen, the display unit 40 displays a function area that corresponds to the current operation.

Still referring to FIG. 5, other units of the first preferred embodiment will be explained. The user tactilely detects a number based upon the number indicator or the Braille expressions on the template and inputs the number in the keypad input unit 50. In the non-visual mode, the keypad input unit 50 sends the inputted number to the voice output unit 60. The voice output unit 60 retrieves the voice information from the voice data file based upon the template number and the user inputted number. Furthermore, the voice output unit 60 plays the voice data. As described before, the voice data includes the function name and helpful information that corresponds the user inputted number. If the above information is stored in the text data format, a voice synthesis process generates voice data for output. After hearing the above voice guide information, if the user determines that the described operation is her desired function, she makes a contact with the touch panel by directly touching a corresponding area on the template. The touch input unit 70 includes the touch panel and executes the specified function in the above manner as if it were inputted during the visual operation mode. Based upon the execution result, the control unit 10 coordinates with the template control unit 30 in order to place a new template for a new operation display. Furthermore, the control unit 10 displays the new operation display on the display unit 40.

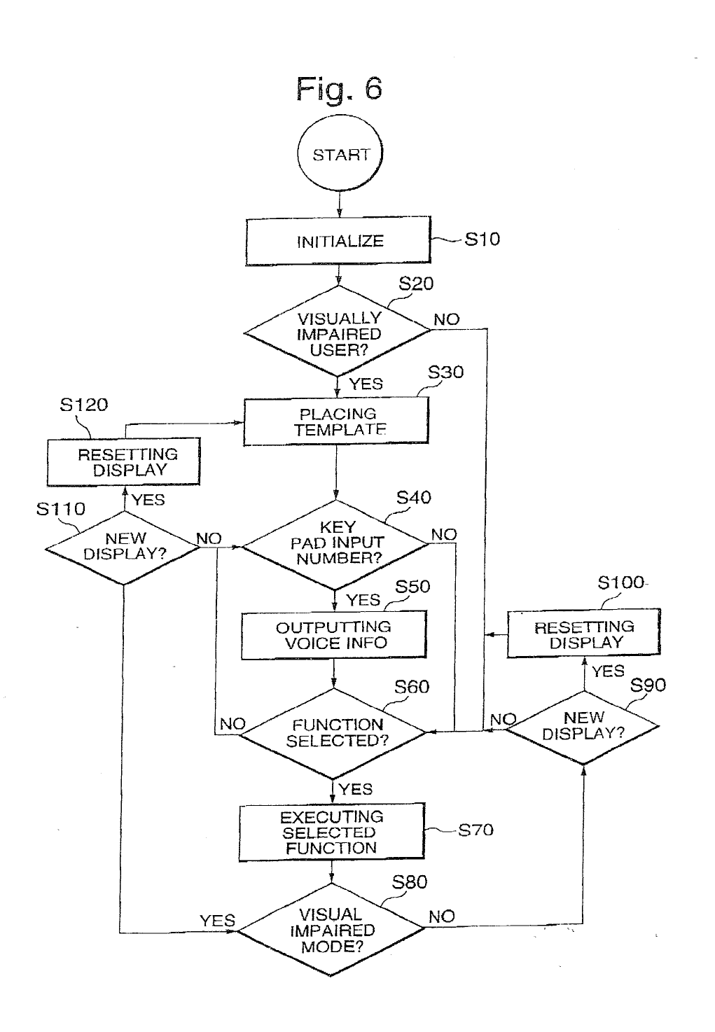

Now referring to FIG. 6, a flow chart illustrates steps involved in a preferred process of the user interface according to the current invention. The preferred process will be described with respect to the above units or components of the user interface device as illustrated in the first preferred embodiment. In a step S10, the control unit 10 initializes user specified initialization items. In the system initialization step S10, the control unit 10 also controls the system to display function areas for an initial operation screen on the operation panel. Finally, the control unit 10 sets the operation mode to be in the visual operation mode in the step S10. In a step S20, it is determined whether or not a visually impaired individual uses the user interface device. The visually impaired individual is detected when the user inserts into the user interface device a head set that includes a microphone and an ear phone. The visually impaired individual is also detected from a certain predetermined key or a non-contact IC card. The non-contact IC card contains information on the visually impaired identification or the historical operational record of a particular individual. In a step S30, upon detecting the visually impaired individual, the control unit 10 set the current operation in the non-visual operation mode. In the non-visual operation mode, the template control unit 30 fetches a template based upon a specified template number from the juke box storage and places it on the operational panel in the step S30.

After the appropriate template is placed, the user touches the template to identify the numbers or the Braille expressions by tactile sensation in a step S40. It is determined in the step S40 whether or not the user enters the identified number via the keypad 50. If the number has been entered in the step S40, the keypad 50 sends the inputted number and the current template identification number to the voice output unit 60 in a step S50. The voice output unit 60 in turn searches among matching voice data files based upon the inputted number and the current template identification number and retrieves a matching voice data file in the step S50. Furthermore, the voice output unit 60 plays the voice data including the function name and helpful information in the step S50. If the above information is stored in the text data format, a voice synthesis process generates voice data. The user listens to the above voice message through the headset and determines whether or not the function is desirable. It is determined in a step S60 whether or not the desired function has been specified through the touch panel. If no function is desirable, the preferred process returns to the step S40 for additional information on other functions. On the other hand, if the user determines that the described function is desirable, she touches the corresponding function area on the touch screen on the touch input unit 70. After selecting a particular function, the touch input unit 70 executes the selected function in a step S70.

Finally, after the execution of the selected function, it is checked if the current operation is running under the visual or non-visual mode in a step S80. For the non-visual mode, it is further determined in a step S110 whether or not a new operation display screen should be provided as a result of the above function execution in the step S70. In a step S120, the control unit 10 replaces the current screen with the new operation display screen, and the template control unit 30 fetches the corresponding template from the juke box storage and places it on the operational panel. If it is determined in the step S110 that no new display is needed, the preferred process returns to the step S40.

Still referring to FIG. 6, the operations will be described in the visual mode. If it is determined in the step S20 that no visually impaired user utilizes the interface device, the preferred process proceeds to the above step S60. In the step S60, the visually normal user selects a desired function by touching a corresponding function area on the above touch screen input unit 70 in substantially the same manner in the visual operation mode. After selecting a particular function, the touch input unit 70 executes the selected function in the step S70 in the visual operation mode. After the function is executed, it is checked if the current operation is running under the visual or non-visual mode in a step S80. For the visual mode, it is further determined in a step S90 whether or not a new operation display screen should be provided as a result of the above function execution in the step S70. In the step S100, the control unit 10 replaces the current screen with the new operation display screen, and the template control unit 30 fetches the corresponding template from the juke box storage and places it on the operational panel. If it is determined in the step S90 that no new display is needed, the preferred process returns to the step S60.

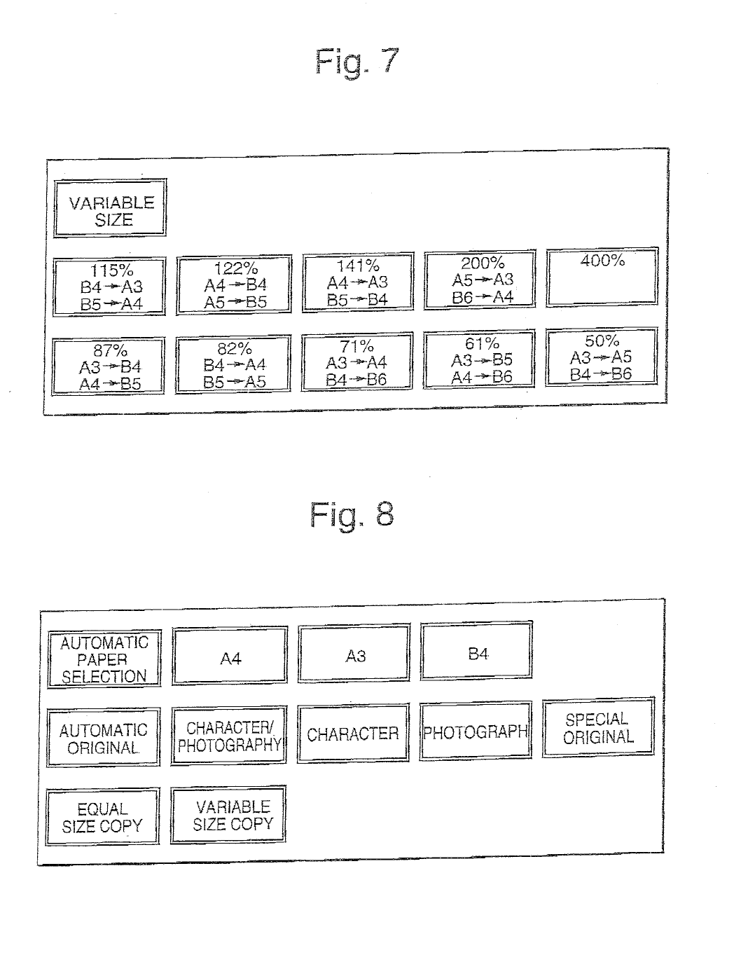

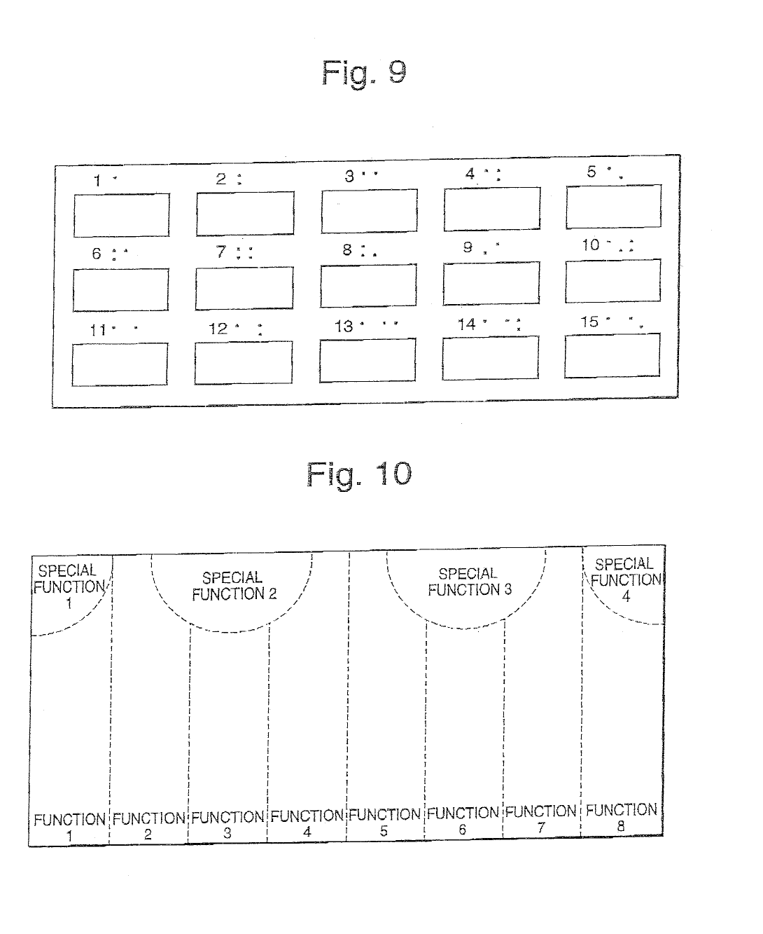

Now referring to FIGS. 7, 8 and 9, diagrams illustrate a fourth, fifth and sixth templates of a second preferred embodiment according to the current invention. The first preferred embodiment requires numerous templates that correspond to various operation screens. Since these templates have to be stored and to be selected, the associated costs are relatively high for manufacturing the additional units. In contrast to the first preferred embodiment, the second preferred embodiment is designed to be fixed in a number of buttons and their positions for various operation screens. Since the second preferred embodiment involves a single template that is used for a plurality of operation screens, the associated cost is not prohibitively expensive. FIGS. 7 and 8 respectively illustrate the fourth and fifth templates to be used for the operation of a copier. The fourth template is placed at the same relative location over the fixed function areas. The multiple labels placed at most predetermined locations. For example, the function area has three labels including “115%,” “B4→A3” and “B5→A4” in the middle row in the most left column of the fourth template. As shown in FIG. 8, the fifth template is placed at the same relative location over the fixed function areas, but not all of the function areas coincide with those of the fourth template. Similarly, FIG. 9 illustrates the sixth template that incorporates both the number indicator and the Braille expressions for indicating each of the predetermined function areas at the fixed locations. The sixth template is constructed as one of the three templates that have been already described with respect to FIGS. 1, 2 and 3.

The user interface device using the above described template includes the units or the components as shown in FIG. 5. However, the following points differ from the first preferred embodiment. In the non-visual operation mode, the control unit 10 in the second preferred embodiment controls the template control unit 30 to fetch a single template and places it on the operational panel. After the operation screen changes, although the same template remains, the operation number changes. The keypad input unit 50 sends the input number and the operation number to the voice output 60. The voice output unit 60 retrieves the voice information from the voice data file based upon the template number and the user inputted number.

Now referring to FIG. 10, a diagram illustrates a seventh template of a third preferred embodiment according to the current invention. In the first and second preferred embodiments, a template is plated over the operational panel. Based upon the template, the informational voice message is obtained for the function areas on the touch panel so that the visually impaired users operate the touch panel. In contrast, the third preferred embodiment does not rely upon the above template. The entire portion of the touch panel is divided into functional areas, and the divided functional areas are directly touched without a template. One exemplary division of the touch panel is illustrated in FIG. 10. In addition to the predetermined function areas 1 through 10, there are four special function areas 1 through 4. In the non-visual mode, each of these areas is associated with a predetermined function. The predetermined function areas 1 through 10 and the special function areas 1 through 4 are arranged like a keyboard of the piano or the organ for identifying the location of each functional area. A number of total keys is equal to the number of the predetermined functions for a particular set of operations. The touch panel screen displays the functional area of the visual operation mode. After a function is executed, the touch screen displays replaces the functional areas with the execution result. A visually normal user is able to advise the visually impaired user based upon the execution result.

In addition to the above described virtual keyboard arrangement, certain special positions are used to facilitate the identification of the position on the touch panel. For example, these special positions include four corners or central positions. To these special locations, special functions are associated. Exemplary special functions include clearing the setting and jumping to the top layer. The special function keys are placed in the upper portion while the operational function keys are placed in the lower portion where virtual keyboard keys are placed. The above described arrangement is used to standardize the key arrangement. The finger movements on the virtual keyboard generally involve the right-left movements for selecting a function. For example, another movement is a vertical movement that is easily distinguished from the above horizontal movement. When the vertical movement exceeds a predetermined speed value, a certain specific functions is executed. For example, the above vertical movement causes to execute a “go back” function which returns to a previous operation screen from the current operation screen. The above arrangement increases the flexibility in the operation of the system. Similarly, certain predetermined functions are selected for execution when predetermine finger movements in certain shapes are detected over the piano keyboard. For example, the finger is moved in a circular, triangular or crossing fashion over the piano keyboard, the corresponding function is executed.

As the touch panel is directly used, the movement from one end to the other on the touch panel is more quickly accomplished than the above described templates. By placing the functions along the edges of the touch panel, it is easier to determine the relative current position based upon tactile sensation. Furthermore, when a finger tip stays in a function area on the touch panel for a predetermined amount of time, the user interface device provides the voice message help for the corresponding function. After the finger is released from the function area, if the finger touches the same function area and releases within a predetermined amount of time, the corresponding function is selected. The above described touch procedure eliminates the use of the keypad for obtaining the voice message. Alternatively, a certain key on the keypad is predetermined for executing a function that is specified on the touch panel. One smooth operation is that a function is specified by touching a corresponding function area with one hand while the selection of the specified function is made by pressing the specified key by the other hand.

The operation method will be described for the touch panel having operation functions. When a finger touches one key of the above described virtual piano keyboard, a corresponding sound icon such as a piano sound is outputted. The sound icon is relatively small and corresponds to the position of the key in the keyboard. The corresponding information is also provided by the voice message, and the information includes a function name and the function description. The above sound icon is generated in stereo by varying the right and left channels, and the stereo sound corresponds to the currently touched position on the touch panel whose virtual piano keys have been assigned a special function. For example, a louder sound is outputted by the left speaker than the right speaker when a function on the left side is touched on the touch panel. By the same token, a louder sound is outputted by the right speaker than the left speaker when a function on the right side is touched on the touch panel. Thus, the identification of the current position is facilitated by the sound icon.

Certain functions are temporarily disabled for selection due to a combination of items. The pitch for the disable functions remains the same in the sound icon, but the tone of the sound icon and the quality of the voice message are modified to clearly indicate the temporarily disabled state to the user. Furthermore, the generation of the sound icon and the voice message is immediately interrupted upon detecting the change in the currently touched piano key on the touch panel. The sound icon and the voice message are resumed for the newly touched piano key. According to the above responsive sound management, since the user does not have to listen to the end of a message after touching a new key, the operation is smooth to the user. After the user selects a function, when the corresponding operation screen evolves, the function assignment is also changes on the virtual piano keyboard of the touch panel.

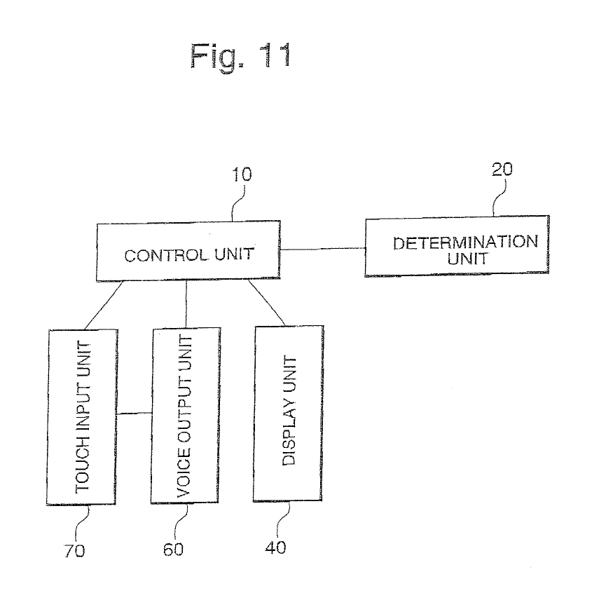

Now referring to FIG. 11, a diagram illustrates the operation user interface device of the third preferred embodiment according to the current invention. The preferred embodiment includes a control unit 10, a determination unit 20, a display unit 40, a voice output unit 60 and a touch input unit 70. The control unit 10 performs various initialization steps. In general, the function areas assigned to the touch panel are based upon the function number and the area definition, and the above basic information is stored in a function area definition file for each operation screen. For example, the function areas include both the function areas and the special function areas in the virtual keyboard touch panel. The current operation screen is assigned a unique operation screen number to identify the current operation screen. Based upon the user touch position on the touch panel and the function area definition, it is determined which function has been touched. Furthermore, the voice data for the specified operation function is identified by the function number, and a set of the function number, the function name and the voice message is stored for each function area in the voice data file. The data structure of the voice data file is substantially identical to the one as shown in FIG. 4. If the above information is stored in the text data format, a voice synthesis process generates voice data for output. The voice data file also includes the voice message for the above described special functions.

The control unit 10 performs various initialization steps. The control unit 10 also controls the entire operation user device as well as the user specified information. The determination unit 20 determines whether or a current user is visually impaired in response to the control unit 10. The determination unit 20 determines the above inquiry based upon the information from the control unit 10. The above information is generated when a headset including a headphone and a microphone is inserted in the user interface device. The information is also generated in response to a certain predetermined key or a non-contact IC card. The non-contact IC card contains information on the visually impaired identification or the historical operational record of a particular individual. The touch input unit 70 includes the touch panel and determines an area in the virtual keyboard based upon the user finger position and the touch duration. The touch input unit 70 outputs the corresponding function number and the operation screen number to the voice output unit 60. The voice output unit 60 retrieves the voice information from the voice data file based upon the function number and the operation screen number. Furthermore, the voice output unit 60 plays the retrieved voice data. As described before, the voice data includes the function name and helpful information that corresponds the user inputted number. If the above information is stored in the text data format, a voice synthesis process generates voice data for output. After hearing the above voice guide information, if the user determines that the described operation is her desired function, she makes a contact with the touch panel. The touch input unit 70 includes the touch panel and executes the specified function in the above manner. Based upon the execution result, the control unit 10 displays the new operation display on the display unit 40. A new operation screen number is assigned.

The functions of the above described preferred embodiments are implemented in software programs that are stored in recording media such as a CD-ROM. The software in the CD is read by a CD drive into memory of a computer or another storage medium. The recording media include semiconductor memory such as read only memory (ROM) and involatile memory cards, optical media such as DVD, MO, MD or CD-R and magnetic media such as magnetic tape and floppy disks. The above software implementation also accomplishes the purposes and objectives of the current invention. In the software implementation, the software program itself is a preferred embodiment. In addition, a recording medium that stores the software program is also considered as a preferred embodiment.

The software implementation includes the execution of the program instructions and other routines such as the operating system routines that are called by the software program for processing a part or an entire process. In another preferred embodiment, the above described software program is loaded into a memory unit of a function expansion board or a function expansion unit. The CPU on the function expansion board or the function expansion unit executes the software program to perform a partial process or an entire process to implement the above described functions.

Furthermore, the above described software program is stored in a storage device such as a magnetic disk in a computer server, and the software program is distributed by downloading to a user in the network. In this regard, the computer server is also considered to be a storage medium according to the current invention.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

1-12. (canceled)

13. A method of user interfacing a visually impaired user with a multifunction device, comprising the steps of:
dividing a touch panel into predetermined surface areas that resemble a piano keyboard;
assigning a predetermined function to each of the predetermined surface areas;
touching one of the predetermined surface areas in a first predetermined manner indicative of an inquiry;
outputting a sound output about the one of the surface areas in response to the inquiry; and
touching one of the predetermined surface areas in a second predetermined manner to select the predetermined function.

14. The method of user interfacing a visually impaired with a multifunction device according to claim 13 wherein the sound output includes a unique sound icon.

15. The method of user interfacing a visually impaired with a multifunction device according to claim 13 wherein the sound output includes a voice message.

16. The method of user interfacing a visually impaired with a multifunction device according to claim 15 wherein the voice message includes a function name.

17. The method of user interfacing a visually impaired with a multifunction device according to claim 16 wherein the voice message additionally includes a description of the function.

18. The method of user interfacing a visually impaired with a multifunction device according to claim 13 further comprising an additional step of identifying the visually impaired user.

19. The method of user interfacing a visually impaired with a multifunction device according to claim 13 wherein the piano keyboard is selected from a set of predetermined keyboard, each of the keyboards corresponding to a particular set of predetermined functions.

20. The method of user interfacing a visually impaired with a multifunction device according to claim 13 wherein a set of predetermined surface areas are assigned to predetermined special functions, the predetermined surface areas being detected by tactile sensation.

21. The method of user interfacing a visually impaired with a multifunction device according to claim 13 wherein one of the predetermined surface areas is disabled, the sound output includes a sound icon and a voice message, at least one of the sound icon and the voice message being modified to indicate a disabled state.

22. The method of user interfacing a visually impaired with a multifunction device according to claim 13 wherein the sound output including a sound icon and a voice message, at least one of the sound icon and the voice message being generated in stereo to reflect an approximate position on the piano keyboard.

23. The method of user interfacing a visually impaired with a multifunction device according to claim 13 wherein the sound output is immediately terminated upon detecting the touch on the piano keyboard.

24. The method of user interfacing a visually impaired with a multifunction device according to claim 13 wherein computer instructions are used to facilitate certain steps, the computer instructions being stored in a recording medium.

25. The method of user interfacing a visually impaired with a multifunction device according to claim 13 further includes an additional step of detecting a set of predetermined movements over the keyboard in one of predetermined shapes to select a predetermined function.

26-40. (canceled)
